(19) United States
(12) Patent Application Publication
(10) Pub. No.: US 2008/0037814 A1
(43) Pub. Date: Feb. 14, 2008

(54) PRECISION AUDIO SPEAKERS

(76) Inventor: Jeng-Jye Shau, Palo Alto, CA (US)

Correspondence Address: JENG-JYE SHAU, 991 AMARILLO AVE., PALO ALTO, CA, 94303, US

(21) Appl. No.: 11/463,424

(22) Filed: Aug. 9, 2006

(51) Int. Cl. H04R 1/20; H04R 1/02

(52) U.S. Cl. 381/337; 381/347

(57) ABSTRACT

The present invention is related to sound generating devices such as audio speakers. Prior art audio speakers typically have inertia related distortion. The present invention provides methods and structures to solve the inertia distortion problem by stop-and-forget mechanism using stoppers.

### BACKGROUND OF THE INVENTION

The present invention relates to sound generating devices, and more particularly to methods or structures used to solve inertia distortion of sound generating devices.

A speaker discussed in the present invention is a device that translates electrical input signals into sound waves as output signals. FIG. 1(a) shows the cross-section views for one example of a typical prior art magnetic speaker. The sound signals are generated by vibration of a diaphragm (100) that is usually made of paper, plastic or metal. The edges of the diaphragm (100) are typically connected to a metal frame called basket (102) by a rim of flexible material called suspension (101). The center of the diaphragm (100) is typically connected to an electrical coil (105) that is connected to the basket (102) by another rim of flexible material called spider (103). A magnet (104) is attached to the bottom of the basket (102). In order to avoid collision with the electrical coil (105), the magnet (104) is typically ring-shaped with an empty space (106) in the middle to allow coil motion. The suspension (101) and the spider (103) attach the diaphragm (100) and the electrical coil (105) to the basket (102) while allowing the diaphragm (100) to move back and forth against the basket (102). When an electrical current is driven through the electrical coil (105), the magnetic force between the electrical coil and the magnet (104) moves the diaphragm (100) back and forth to generate sound signals. The sound signals generated by a prior art magnetic speaker are therefore controlled by the electrical current flowing through the electrical coil (105).

FIG. 1(a) shows the structures of a typical high power speaker that has a corn shaped diaphragm (100). FIG. 1(b) shows the symbolic cross-section views for one example of a typical prior art magnetic speaker that has a dome shaped diaphragm. The sound signals are generated by vibration of a dome shaped diaphragm (110) that is typically made of plastic thin films. The edges of the diaphragm (110) are typically connected to a metal basket (112) by a suspension thin film (111). This suspension thin film (111) is typically made of plastic; it holds the diaphragm (110) in the right positions while providing counter force to the magnetic force applied on the diaphragm. The basket (112) typically has opening (117) on top to allow sound waves passing through. This opening (117) is typically covered by protective clothing (113). A magnet (114) is attached to the bottom of the basket (112). The diaphragm (110) is connected to an electrical coil (115) that fits into open spacing (116) in the magnet (114). When an electrical current is driven through the electrical coil (115), the magnetic force between the electrical coil and the magnet (114) moves the diaphragm (110) up and down to generate sound signals.

The magnetic speaker in FIG. 2(b) is compact in structures so that they can be manufactured in small sizes. Another major type of speakers that can be manufactured in small sizes are condenser speakers. A condenser speaker is basically a capacitor. Condenser speakers can be manufactured using semiconductor manufacture technologies as micro-electro-mechanical systems (MEMS) to achieve excellent precision, uniformity and cost efficiency; condenser speakers also can be manufactured using conventional methods. FIG. 2(a) is a simplified symbolic cross-section diagram for a condenser speaker. A diaphragm (201) is attached to substrate (200) through spacers (202). The spacers (202) provide space between the diaphragm (201) and a metal plate (203) deposited on the substrate (200) to form a capacitor. Typical substrate (200) material is silicon. The diaphragm (201) and the metal plate (203) are typically made of metal thin films. Sometimes the diaphragm (201) is made of insulating materials with trapped electrical charges. When a voltage is applied on the capacitor, electrical charges (204, 205) are separated by the voltage difference. The electrical force between these electrical charges (204, 205) causes the diaphragm (201) to move. Therefore, controlling the voltage on the capacitor can control the sound signals generated by diaphragm (201) movement. FIG. 2(a) illustrates the situation when the diaphragm (201) is pulled toward the substrate (200) by electrical force. FIG. 2(b) illustrates the situation when the electrical force is removed and the diaphragm (201) is swinging back to equilibrium position. The momentum generated by the displacement in FIG. 2(a) keeps the diaphragm (201) moving with an upward momentum (217) so that it would not stop at the equilibrium position. FIG. 2(c) illustrates the situation when the upward momentum (217) in FIG. 2(b) makes the diaphragm (201) move above the equilibrium position. Due to moment of inertia, the diaphragm can vibrate back and forth a few more cycles after release of electrical force before it can rest in the equilibrium position.

Ideally, the sound signals generated by the speakers should be proportional to the electrical input signals. Unfortunately, that is typically not true for prior art speakers. One common problem is the non-linear distortion happened at large vibration amplitudes. Such problem can be avoided by controlling the operating condition within linear region of a given speaker. Another problem is more difficult to handle. The diaphragm is a mechanical structure with motion inertia. As illustrated in FIGS. 2(a-c), the motion of the diaphragm is not necessary proportional to electrical driving force due to the inertia of moving diaphragm.

FIGS. 2(d-f) are simplified examples for the input or output waveforms of speaker signals. The vertical axis is the amplitude of input or output signal, while the horizontal axis is time. FIG. 2(d) shows a simplified case when the electrical input signal is a single pulse (231). The desired result on the output sound wave would be a single pulse (241) as illustrated in FIG. 2(e). However, due to the inertia of the diaphragm, the measured sound waveform in FIG. 2(f) shows an over-shoot (252) and multiple damping vibrations (253) after the signal pulse (251). The measured data in FIG. 2(f) tell us that an input pulse can influence the speaker output many cycles after the input pulse went away. The above discussions on a single pulse are applicable to complex cases because we can treat any input signals as a series of overlapped pulses. The measured data in FIG. 2(f) show that the speaker outputs are actually the overlapped results of electrical signals at different time, causing distortions in output sound signals. At any given time point, the output of a prior art speaker is not only driven by the electrical input signal at the time point but also influenced by the inertia of momentum caused by signals at earlier time, causing distortions in the output signals. We will call such type of distortion as “inertia distortion” in the following discussions.

Based on similar reasons, the magnetic speakers shown in FIG. 1(a) also have similar inertia distortion problems. The major prior art method to solve inertia distortion problem is to introduce damping force by controlling the materials and structures of the suspension materials (101, 103, 111). Such prior art damping methods are often not effective for wide range of output frequencies. Almost all prior art speakers have the inertia distortion problem, including those expensive speakers. The inertia distortion is sensitive to detailed speaker structures. That is one of the major reasons why prior art speakers can have different sound characteristics for the same input signals. It is strongly desirable to use cost effective methods to remove inertia distortion.

### SUMMARY OF THE INVENTION

The primary objective of the present invention is to provide structures and methods to improve inertia distortion. This objective is achieved by providing stopper(s) to absorb the momentum of a moving diaphragm. Unlike prior art methods that require damping mechanisms to reduce inertia distortion, the present invention provides stopper(s) in the moving path of the sound generating structures to absorb momentum. This method allow us to stop the motion of sound generating structures at wide frequency range, providing effective methods to remove inertia distortion for sound generating devices.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIGS. 1(a, b) are cross-section diagrams of prior art magnetic speakers;

FIGS. 2(a-c) illustrate the structures and motions of a prior art condenser speaker;

FIG. 2(d) shows an input signal comprising a single pulse;

FIG. 2(e) shows desired output sound signals when the input signal is shown in FIG. 2(d);

FIG. 2(f) shows measured output sound signals of a prior art speaker when the input signal is shown in FIG. 2(d);

FIGS. 3(a-d) are cross-section diagrams for examples for the condenser speakers of the present invention;

FIGS. 4(a-c) are cross-section diagrams for examples for the magnetic speakers of the present invention;

FIGS. 5(a-c) are cross-section diagrams of examples for the magnetic speakers of the present invention;

FIG. 6(a) illustrates the operation for an array of speaker units; and

FIG. 6(b) shows example cross section structures for individual speaker unit in FIG. 6(a).

### DETAILED DESCRIPTION OF THE INVENTION

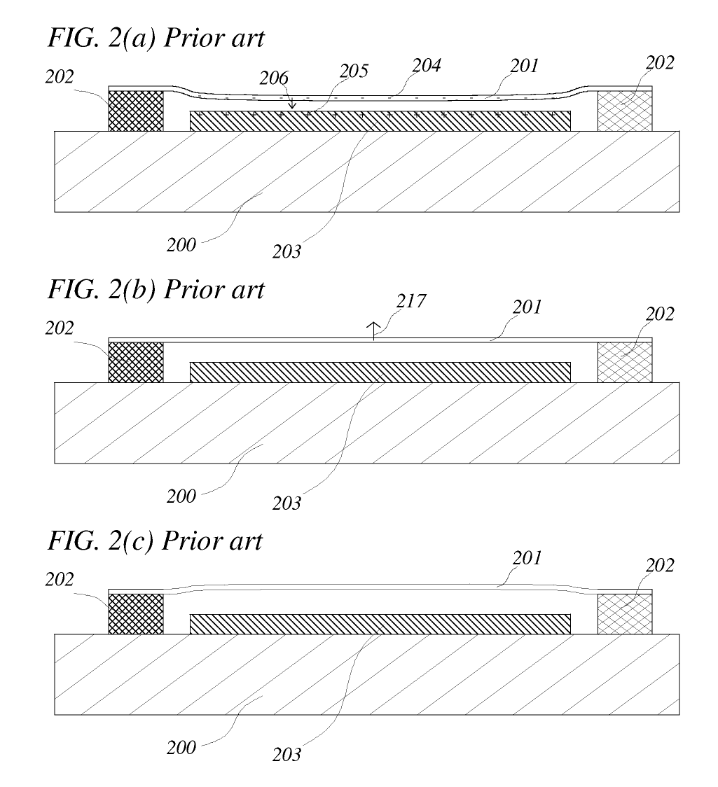

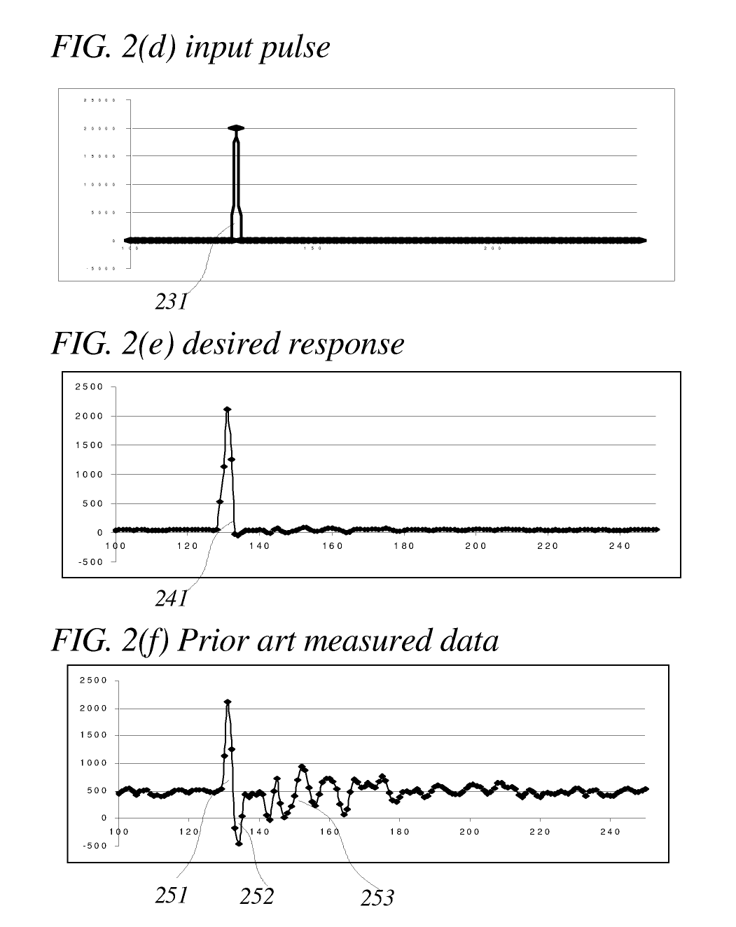

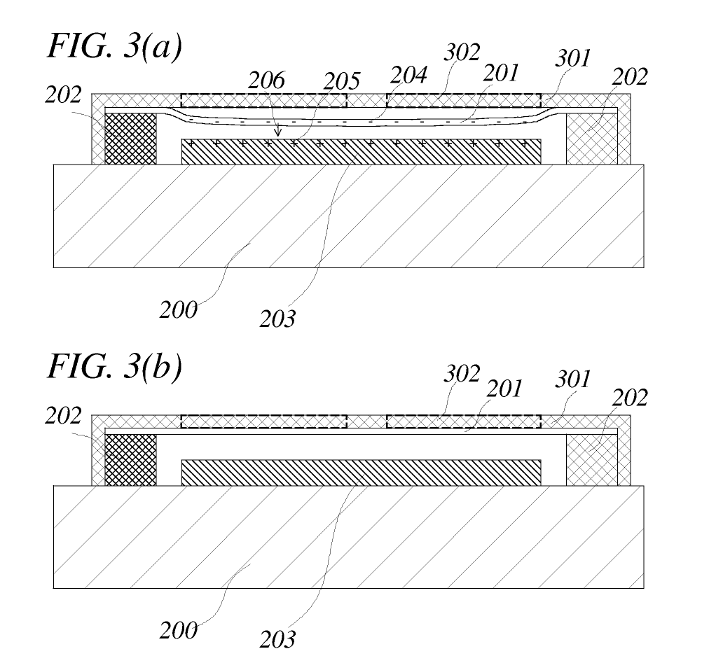

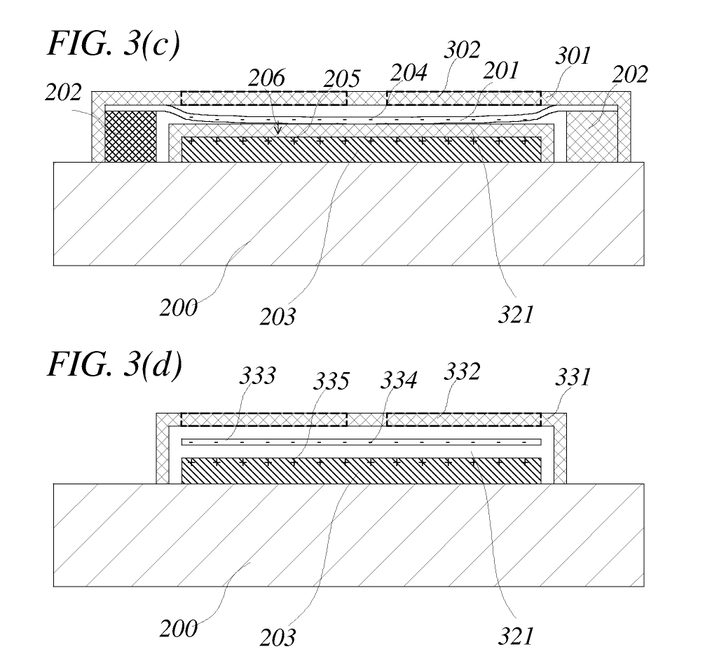

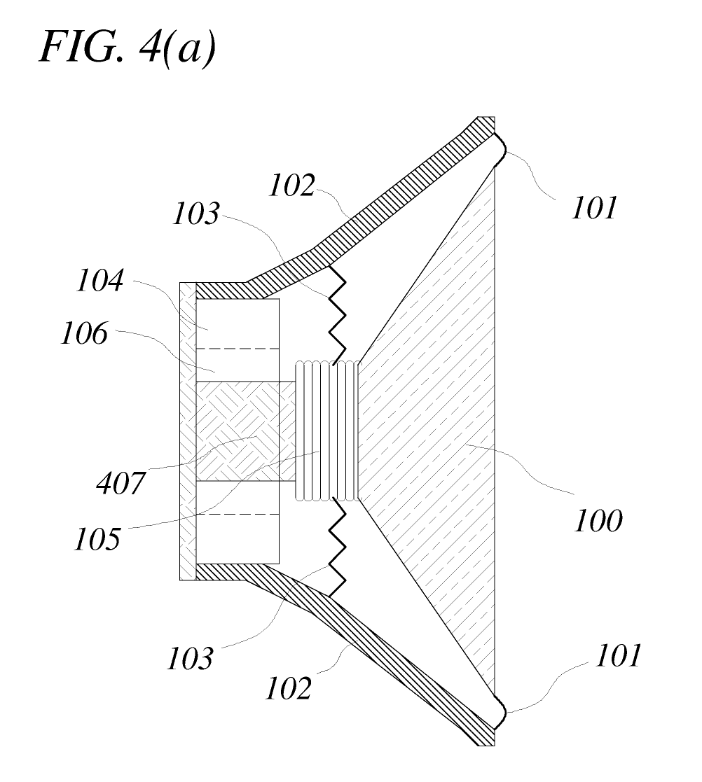

FIG. 3(a) shows the cross-section structures of a condenser speaker of the present invention. The structures (200-205) of this speaker are identical to those of the prior art speaker shown in FIG. 2(a) except that this magnetic speaker has a stopper (301). This stopper (301) is made of momentum absorbing materials that can stop or absorb most of the momentum of the diaphragm (201) upon contact. This stopper (301) has openings (302) so that the diaphragm (201) motion can push/pull air through the openings (302) to generate sound signals. When a voltage is applied on the capacitor, the separated electrical charges (204, 205) generate an electrical force between the diaphragm (201) and the plate (203), causing the diaphragm (201) to move in similar ways as the prior art condenser speaker shown in FIG. 2(a). When the voltage is removed, the diaphragm moves back to the equilibrium condition as illustrated in FIG. 3(b). The situation in FIG. 3(b) is different from that in FIG. 2(b) because the diaphragm (201) motion is stopped by the stopper (301). The diaphragm (201) will stays at equilibrium position with no momentum as illustrated in FIG. 3(b). Since there is no overshoot action like FIG. 2(c), the output signal of this condenser speaker of the present invention is equal to the ideal waveform shown in FIG. 2(e). When we can stop the motion of the diaphragm (201) using a stopper (301), the diaphragm will “forget” the influences of previous actions, allowing us to start fresh new motions without influence of previous cycles. Therefore, the stopper (301) effectively removes the inertia distortion. We call such mechanism of the present invention as “stop-and-forget” (SAF) mechanism. The SAF mechanism allows us to generate sound output signals cycle by cycle without the influence of the signals in previous cycles. It is therefore much easier to control output signals that are proportional to input signals.

While specific embodiments of the invention have been illustrated and described herein, it is realized that other modifications and changes will occur to those skilled in the art. There are many ways to implement the SAF mechanism. For the example shown in FIGS. 3(a-b), one stopper is placed at the equilibrium position. The example in FIG. 3(c) has two stoppers (302, 321) and they are not necessarily placed at equilibrium position. There is a top stopper (302) that allows the diaphragm (201) to rest at high position, and there is a bottom stopper (321) that allows the diaphragm (201) to rest at low position.

The spacers (202) are important structures for prior art condenser speakers. They provide mechanical supports for the diaphragm (201). The bandwidth and reliability of prior art speakers are related to the properties of the spacers (202). However, for the speaker of the present invention in FIG. 3(c), the motion of the diaphragm (201) is limited by stoppers (302, 321) so that we no longer need the spacers (202) to hold the diaphragm in position. FIG. 3(d) shows a condenser speaker of the present invention that does not have spacers. In this example, a diaphragm (333) can move freely in the space (321) between a stopper (331) and a plate (203); the diaphragm (333) is no longer connected to substrate (200) through spacers. This diaphragm (333) is typically a light weight insulator with trapped charge (334) such as a plastic thin film. When a voltage is applied on the capacitor, electrical charges (335) separated by the voltage can force the diaphragm (331) to move within the space defined by the stopper (331). The stopper (331) has openings (332) so that the motion of the diaphragm (333) can generate sound waves. The example in FIG. 3(d) can have wider bandwidth because of free motion. It also has better reliability. In our simplified drawing, the diaphragm (333) in FIG. 3(d) appear to be floating in the space; in reality, we may put soft materials to hold the diaphragm (333) within proper positions.

While specific embodiments of the invention have been illustrated and described herein, it is realized that other modifications and changes will occur to those skilled in the art. For example, similar principles are applicable to magnetic speakers.

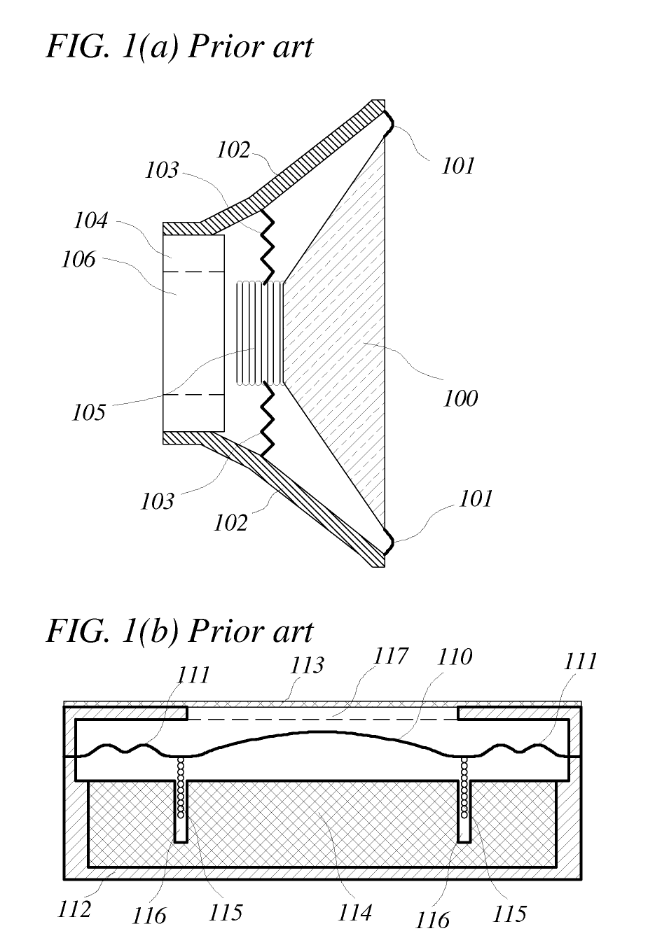

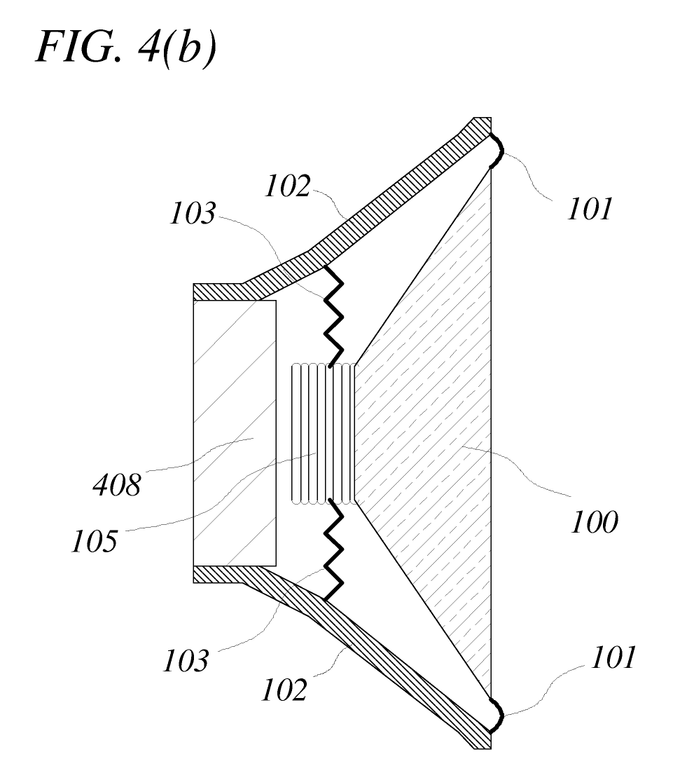

FIG. 4(a) is a cross-section diagram for a magnetic speaker of the present invention. The structures (100-106) of this magnetic speaker are identical to those of the prior art speaker in FIG. 1(a) except that this speaker has a stopper (407). The stopper (407) is placed in the center space (106) of the magnet ring (104). This stopper (407) is made of momentum absorbing materials such as spongy plastic materials so that the coil (105) and the diaphragm (100) will stop upon contacting the stopper (407). The stopper (407) provides SAF mechanism to remove inertia distortion of the speaker.

FIG. 4(b) is a cross-section diagram for another magnetic speaker of the present invention. The structures (100-103,105) of this magnetic speaker are identical to those of the prior art speaker in FIG. 1(a) except that the prior art speaker in FIG. 1(a) uses a ring-shaped magnet (104) with center spacing (106) while the speaker in FIG. 4(b) use a solid magnet (408) without center spacing. The solid magnet (408) provides magnetic force like the prior art magnet (104) while the solid magnet (408) also servers the functions of a stopper. FIG. 4(c) is a cross-section diagram for another magnetic speaker of the present invention. The structures (100-103, 105, 408) of this magnetic speaker are identical to those of the prior art speaker in FIG. 4(b) except that a layer of cushion (409) is placed in front of the solid magnet (408). This cushion (409) helps in smoothing the impacts of the stop actions. The speakers in FIGS. 4(b, c) are examples showing that SAF mechanisms of the present invention can be implemented by cost effective modifications of existing prior art speakers.

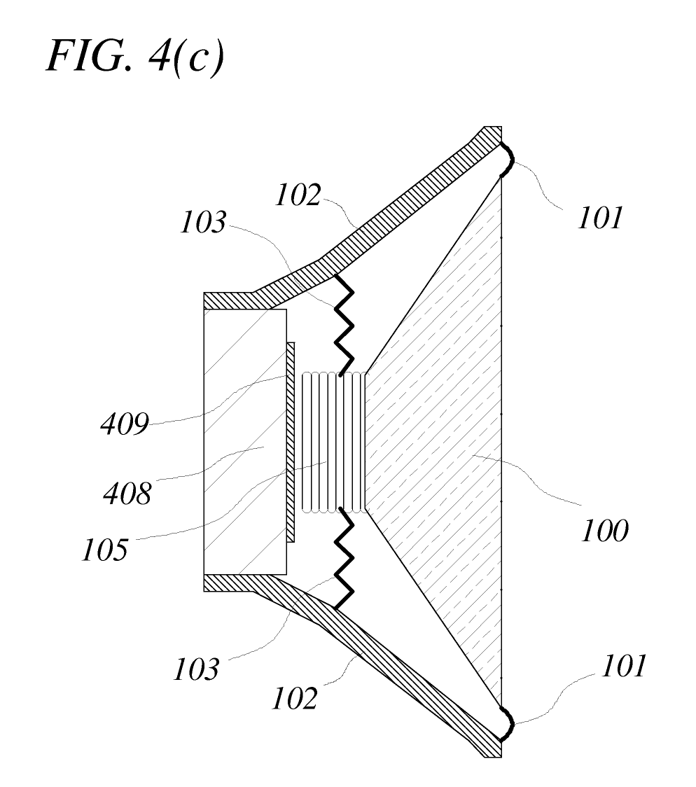

While specific embodiments of the invention have been illustrated and described herein, it is realized that other modifications and changes will occur to those skilled in the art. FIGS. 5(a-c) show examples for different variations of the present inventions.

FIG. 5(a) is a cross-section diagram for a magnetic speaker of the present invention. The structures (110-117) of this magnetic speaker are identical to those of the prior art speaker in FIG. 1(b) except that stoppers (518) are placed to limit the upward motion of its diaphragm (110). This stopper (518) is made of momentum absorbing materials such as spongy plastic so that the coil (115) and the diaphragm (110) will stop upon contacting the stopper (518). The stopper (518) provides SAF mechanism to remove inertia distortion of the speaker.

FIG. 5(b) is a cross-section diagram for another magnetic speaker of the present invention. The structures (110-117, 518) of this magnetic speaker are identical to those of the speaker in FIG. 5(a) except that another cushion stopper (526) is placed at the bottom of the spacing (116) in the magnet (114). This cushion stopper (526) is made of momentum absorbing materials such as spongy fibers so that the coil (115) will stop upon contacting the stopper (526). This stopper (526) limits the downward motion of the diaphragm (110) to provide SAF mechanism for reducing inertia distortion of the speaker.

FIG. 5(c) is a cross-section diagram for another magnetic speaker of the present invention. The structures (112-117, 518, 526) of this magnetic speaker are identical to those of the speaker in FIG. 5(b) except that the diaphragm (530) is no longer connected to the basket (112) with the suspension (111). Instead, the position of the diaphragm (530) is supported by soft fillings (531) that is typically made of soft plastic or fiber materials. The soft fillings (531) keep the diaphragm (530) centered while providing nearly no vertical force against the magnetic force. For the prior art device in FIG. 1(b), the magnetic force on the diaphragm (110) pulls against the elastic force of the suspension (111). Therefore, the prior art speaker consumes power even when the diaphragm is held at the same position (the only exception is at the equilibrium position). The device in FIG. 5(c) does not fight against the suspension so that it consumes power only when we want to change the diaphragm positions defined by stoppers (518, 526). The device does not need to consume power when the diaphragm is at resting positions. Therefore, the magnetic speaker in FIG. 5(c) is able to consume less power while operating at higher frequency. The same principles are applicable to other types of sound generating devices of the present invention, such as the condenser speaker in FIG. 3(d).

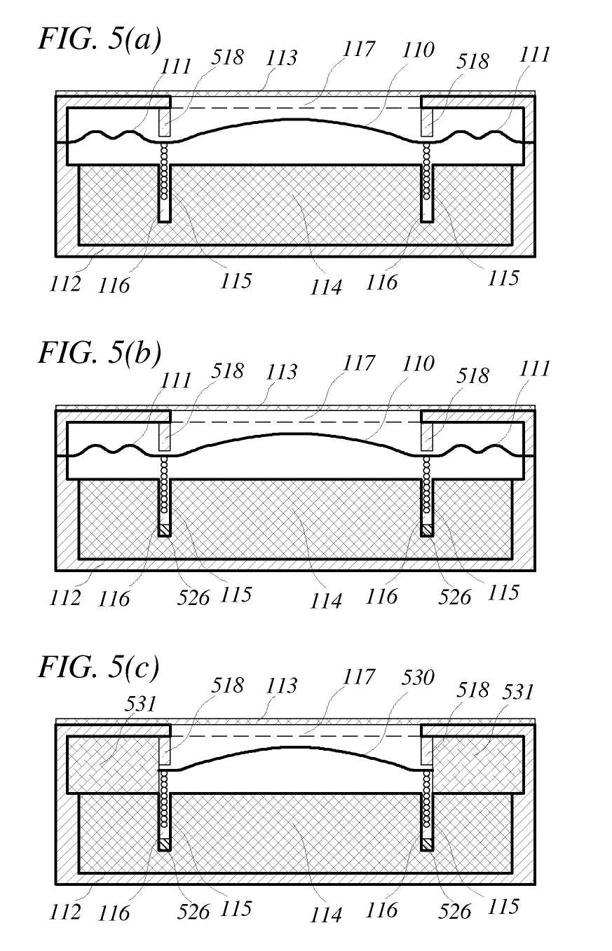

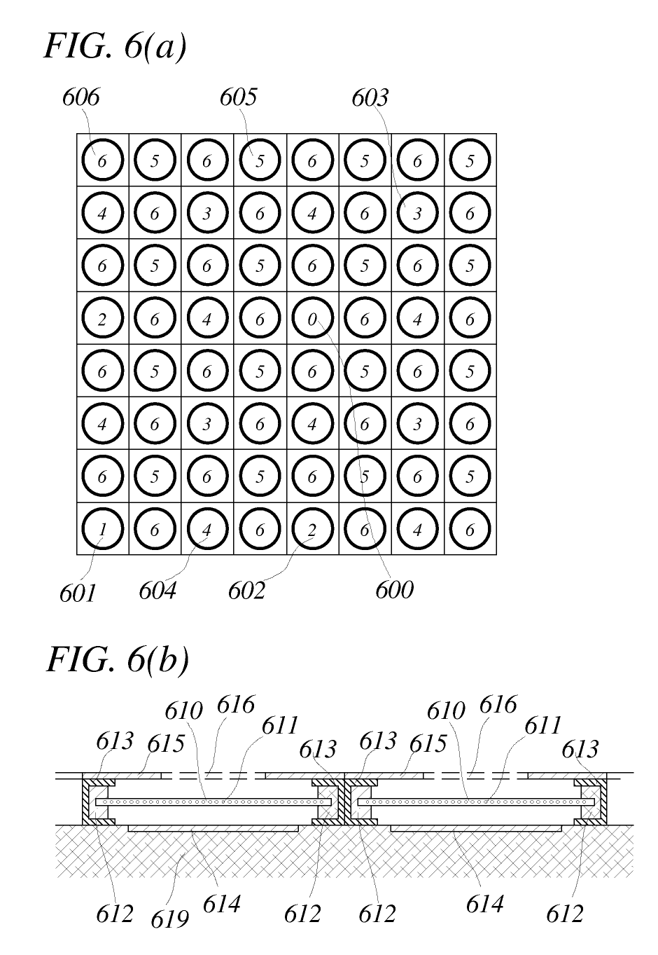

One disadvantage of the present invention is that the amplitude of the output sound signal is limited by the stoppers. One solution for this limitation is to use a plurality of speaker units with nearly uniform properties as illustrated in FIG. 6(a). In this example, 64 speaker units (601-606) of the present invention form a speaker array. The maximum output amplitude of this 64-unit array is therefore 64 times larger than that of an individual speaker unit. These speaker units also can form a digital-to-analog sound level converter with 6 bit resolution. For example, if the most significant bit of a 6-bit digital input signal is ‘1’, all the speaker units (606) marked with number 6 should be turned on; if the second most significant bit of a 6-bit digital input signal is ‘1’, all the speaker units (605) marked with number 5 should be turned on; if the third most significant bit of a 6-bit digital input signal is ‘1’, all the speaker units (604) marked with number 4 should be turned on; if the forth most significant bit of a 6-bit digital input signal is ‘1’, all the speaker units (603) marked with number 3 should be turned on; if the fifth most significant bit of a 6-bit digital input signal is ‘1’, all the speaker units (602) marked with number 2 should be turned on; if the least significant bit of a 6-bit digital input signal is ‘1’, the speaker unit (601) marked with number 1 should be turned on. The speaker unit (600) marked with number ‘0’ provides analog level output signals for detailed variations less than the output of a speaker unit. While most of the speaker units (601-606) are digital speaker units that typically output sound signals with one or a few levels of amplitude, the last speaker unit (600) can be a precision analog speaker with a wide range of output amplitudes. For example, if the digital speaker units (601-606) only output one level of amplitude, while the last speaker unit (600) has 256 level resolutions, the over all speaker array in FIG. 6(a) will have 16384 levels; in other words, the speaker array provides 14-bit resolution.

Prior art high price speaks often comprise speaker array to cover different range of frequency. Each speaker unit in prior art speaker covers a range of output frequency or angle to generate high quality sound effects. The operation principles of those prior art speaker array are different from the speaker array of the present invention.

While specific embodiments of the invention have been illustrated and described herein, it is realized that other modifications and changes will occur to those skilled in the art. There are many ways to design the array speaker in FIG. 6(a). We certainly can have better digital resolutions by using larger array or multiple arrays. Using array speakers will widen the amplitude range with high accuracy. To achieve better resolution, uniformity is an important consideration for array speaker. One major way to achieve better uniformity is to use lithography methods to define the dimensions of the speakers (601-606). Using IC lithography to define at least part of the structures is certainly an effective method to build array speaker uniformly. For better cost efficiency, we also can use printed circuit board (PCB) patterning technologies to define the structures. The individual speakers (601-606) can be any type of speakers or a combination of different types of speakers. For example, we can use condenser speakers defined by IC lithography or PCB patterning technologies.

FIG. 6(b) shows examples for the cross section views for two nearby condenser speaker units that can be used for the speaker array in FIG. 6(a). In this example, the sound generation structure for each speaker unit is a diaphragm (610) with embedded electrical charge (611). The materials and manufacture methods for such charged diaphragm (610) is well known in the art of audio devices. The motion of the diaphragm is confined by stoppers (613). The edge of the diaphragm (610) is wrapped with soft plastic (612). The soft plastic (612) applies little vertical force to the diaphragm (610) so that the diaphragm is free to move in vertical directions. In the mean time, the soft plastic (612) reduces side way motions while prevent direct collision between the diaphragm and the stoppers (613) for reliability consideration. A metal plate (614) is placed on the bottom of the speaker unit, and another metal plate (615) is placed on top of the speaker unit. The top metal plate (615) has openings (616) to allow emission of sound waves. When different voltages are applied between these two metal plates (615, 616), the electrical force generated by the voltage difference can move the charged diaphragm (610) up and down to generate sound signals. The speaker unit is formed on top of a PCB substrate (619). To achieve better uniformity, it is desirable that the structures of these speaker units are defined by PCB patterning technologies or IC lithography technologies.

The present invention uses stoppers to reduce inertia distortion. There are many ways to design stoppers of the present invention. While specific embodiments of the invention have been illustrated and described herein, it is realized that other modifications and changes will occur to those skilled in the art. The scope of the present invention should not be limited by specific examples in our figures. A “stopper” defined in the present invention is a structure placed in the moving path of the sound generating structure(s) in a sound generating device. The stopper is used to reduce the momentum of the sound generating structure by contact, with a purpose to reduce inertia distortion by allowing the next cycle to start without the influence of previous cycles. Typical examples for sound generating devices are audio speakers. Typical examples for sound generating structures are diaphragms of various shapes, including the attached structures such as electrical coils. Strings or vibration plates are other examples for sound generating structures. Stoppers of the present invention limit the range of motion for the sound generating structures in sound generating devices. Unlike conventional damping mechanism, a stopper of the present invention is placed in the way of a moving sound generating structure in order to reduce or stop the momentum of the sound generating structure by contact. The present invention uses stoppers to solve inertia distortion problems of sound generating devices.

While specific embodiments of the invention have been illustrated and described herein, it is realized that other modifications and changes will occur to those skilled in the art. It is to be understood that the appended claims are intended to cover modifications and changes as fall within the true spirit and scope of the invention.

What is claimed is:

1. A sound generating device comprising a sound generating structure and a stopper, wherein said stopper is placed in the motion path of said sound generating structure in order to reduce the momentum of said sound generating structure by contact as a method to reduce inertia distortion.

2. The sound generating structure in claim 1 is a diaphragm.

3. The sound generating structure in claim 1 is a diaphragm plus an electrical coil attached to the diaphragm.

4. The sound generating device in claim 1 is a magnetic speaker.

5. The sound generating device in claim 1 is a condenser speaker.

6. A method for manufacturing a sound generating device comprising the steps of (a) providing a sound generating structure and (b) providing a stopper, wherein said stopper is placed in the motion path of said sound generating structure in order to reduce the momentum of said sound generating structure by contact as a method to reduce inertia distortion.

7. The sound generating structure in claim 6 is a diaphragm.

8. The sound generating structure in claim 1 is a diaphragm plus an electrical coil attached to the diaphragm.

9. The sound generating device in claim 6 is a magnetic speaker.

10. The sound generating device in claim 6 is a condenser speaker.

11. A speaker array comprises a plurality of speaker units, wherein the dimension of speaker units are defined by printed circuit board (PCB) patterning technology.

12. The speaker unit in claim 11 is a condenser speaker.
